(19) United States
(12) Patent Application Publication
(10) Pub. No.: US 2016/0027551 A1
(43) Pub. Date: Jan. 28, 2016

(54) ASSEMBLED CONDUCTOR AND MANUFACTURING METHOD FOR ASSEMBLED CONDUCTOR

(71) Applicant: TOYOTA JIDOSHA KABUSHIKI KAISHA, Toyota-shi (JP)

(72) Inventors: Daisuke MIZUSHIMA, Toyota-shi (JP); Hironari ADACHI, Toyota-shi (JP); Hirofumi INOSHITA, Nagoya-shi (JP)

(73) Assignee: TOYOTA JIDOSHA KABUSHIKI KAISHA, Toyota-shi (JP)

(21) Appl. No.: 14/800,913

(22) Filed: Jul. 16, 2015

(30) Foreign Application Priority Data
Jul. 22, 2014 (JP) 2014-148796

(51) Int. Cl. H01B 5/00; H01B 13/00

(52) U.S. Cl. CPC H01B 5/002; H01B 13/0036

(57) ABSTRACT

The invention provides an assembled conductor, which is formed by rolling a conductor bundle including a central conductor and a peripheral conductor arranged around the central conductor. The central conductor has a shape in which a right-twisted portion of the central conductor and a left-twisted portion of the central conductor are arranged alternately in predetermined intervals. The right-twisted portion of the central conductor extends from one end side of the central conductor to the other end side of the central conductor and is twisted in a clockwise direction, and the left-twisted portion of the central conductor extends from the one end side of the central conductor to the other end side of the central conductor and is twisted in a counterclockwise direction. The peripheral conductor is arranged around the central conductor so that a twist direction of the peripheral conductor becomes opposite to a twist direction of the central conductor.

### INCORPORATION BY REFERENCE

The disclosure of Japanese Patent Application No. 2014-148796 filed on Jul. 22, 2014 including the specification, drawings and abstract is incorporated herein by reference in its entirety.

### BACKGROUND OF THE INVENTION

1. Field of the Invention

The invention relates to an assembled conductor and a manufacturing method for the assembled conductor. The invention relates especially to an assembled conductor, which is formed by rolling a conductor bundle including a central conductor and a peripheral conductor arranged around the central conductor, and to a manufacturing method for the assembled conductor.

2. Description of Related Art

There is an assembled conductor that is formed by bundling conductors. Japanese Patent Application Publication No. 2009-199749 (JP 2009-199749 A) discloses a manufacturing method for an assembled conductor. In the technique disclosed in JP 2009-199749 A, a plurality of wires is stranded together, thus forming a stranded wire. Thereafter, the stranded wire is compression-molded by using dies, thereby forming a rectangular conductor in which the stranded wire has a rectangular section. Then, an insulating layer is formed by covering the outer circumference of the rectangular conductor by using an insulating material, which is made of resin or the like, thereby forming an assembled conductor.

The inventors of the invention thought of a manufacturing method shown in FIG. 12 as an example of a manufacturing method for such an assembled conductor. FIG. 12 is a schematic view of a related manufacturing method. In FIG. 12, schematic views 961 to 966 are schematic views of wires, assembled conductors, or intermediate products of the wires and the assembled conductors in respective steps.

To be specific, a wire feeder 941 feeds a plurality of wires 901 having a circular section to first rolling mill rolls 942, and the first rolling mill rolls 942 roll some of the plurality of wires 901 so that the wires have a given sectional shape, for example, a rectangular section, thereby forming peripheral conductors 902 (see schematic view 962). Further, the first rolling mill rolls 942 feed the peripheral conductors 902 to a conveyer 943, and feed the remainder of the wires 901 to the conveyer 943 as it is as a central conductor 903 without carrying out the rolling. Next, the conveyer 943 spreads out each of the peripheral conductors 902 and makes a positional relation in which the peripheral conductors 902 surround the central conductor 903. The conveyer 943 feeds the central conductor 903 and the spread peripheral conductors 902 to a clamp 944.

Next, the clamp 944 receives the central conductor 903 and the peripheral conductors 902 from the conveyer 943 and forms a conductor bundle 907 by arranging the peripheral conductors 902 around the central conductor 903 and bundling the conductors. The clamp 944 applies given pressure to the conductor bundle 907 towards the center of the conductor bundle 907. Therefore, as shown in schematic view 963, in a section 907a of the conductor bundle 907, the central conductor 903 and the peripheral conductors 902 are brought closer to each other, and the peripheral conductors 902 are also brought closer to each other. The conductor bundle 907 passes through the clamp 944 and a rotating machine 945, and is then fed to a clamp 946.

Next, the clamp 944, the rotating machine 945, and the clamp 946 clamp the conductor bundle 907 and fix the axis of the conductor bundle 907. Moreover, while the clamp 944, the rotating machine 945, and the clamp 946 are clamping the conductor bundle 907, the rotating machine 945 rotates in a given rotating direction 954, twisting the conductor bundle 907. Then, a twisted conductor bundle 908 is formed. The twisted conductor bundle 908 has, for example, a twisted portion and a reversely twisted portion, which are bordered by the rotating machine 945. The twisted portion is twisted so as to be helical around the central conductor 903, and the reversely twisted portion is twisted reversely to the twisting direction of the twisted portion.

As shown in schematic view 964, the twisted conductor bundle 908 is an assembled conductor in which the central conductor 903, and the peripheral conductors 902 having the given shape are aligned. Therefore, the rotating machine 945 is able to form a section 908a in which a substantially circular section 907a of the conductor bundle 907 (see schematic view 963) is maintained.

The clamp 946 applies given pressure to the twisted conductor bundle 908 towards the center of the twisted conductor bundle 908. Therefore, the central conductor 903 and the peripheral conductors 902 are closely adhered to each other, and the peripheral conductors 902 are also closely adhered to each other.

Second rolling mill rolls 947 receive the twisted conductor bundle 908 from the clamp 946. The second rolling mill rolls 947 have a pair of rolls, are rotated by a driving mechanism (not shown), and roll the twisted conductor bundle 908 so that the twisted conductor bundle 908 becomes rectangular.

Further, an insulating film deposition machine 953 received the assembled conductor 810. The assembled conductor 810 is lead to a die hole of a drawing die 953a. The insulating film deposition machine 953 softens a powdered raw material 953f, which is loaded in a hopper 953e, a by heating in advance, injects the raw material 953f to the die hole of the drawing die 953a by using a screw 953d, and further applies pressure to the raw material 953f. Thereafter, the assembled conductor 810 is drawn out to a downstream side from the die hole of the drawing die 953a. Then, a coated assembled conductor 811 is drawn out from the die hole of the drawing die 953a in a state where an insulating film 803 is formed on the outer circumference of the assembled conductor 810. From these steps, the coated assembled conductor 811 is manufactured.

However, in the case where an assembled conductor is formed by using the manufacturing method explained above, twist deformation could happen in the assembled conductor 810 as shown in FIG. 13. Specifically, twist deformation is deformation caused by a change of an angle of the section of the assembled conductor 810 depending on a position of the section on the axis of the assembled conductor 810. For example, upper sides 804b to 804f at measuring points b, c, d, e, f have different angles from each other with respect to an upper side 804a at a measuring point a. FIG. 14 shows an example of a twist angle with respect to a measuring point. As shown in FIG. 14, it appears that the angle of the upper side 804 changes from the measuring point a towards the measuring point fin a given period.

FIG. 15 shows a sectional view of the coated assembled conductor 811 in the case where twist deformation happens. As shown in FIG. 15, when twist deformation happens, the assembled conductor 810 is tilted with respect to the coated assembled conductor 811. To be specific, the upper side 804 of the assembled conductor 810 in the section of the coated assembled conductor 811 is not substantially parallel to an upper side 814 of the insulating film 803 in the section of the coated assembled conductor 811, and is tilted at a given angle. Therefore, there is a possibility that the insulating film 803 is not able to have a thickness required in order to function as a film.

### SUMMARY OF THE INVENTION

Thus, the invention provides an assembled conductor that suppresses twist deformation, and a manufacturing method for the assembled conductor.

An assembled conductor according to an aspect of the invention is an assembled conductor, which is formed by rolling a conductor bundle including a central conductor and a peripheral conductor arranged around the central conductor. The central conductor has a shape in which a right-twisted portion of the central conductor and a left-twisted portion of the central conductor are arranged alternately at predetermined intervals. The right-twisted portion of the central conductor extends from one end side of the central conductor to the other end side of the central conductor and is twisted in a clockwise direction, and the left-twisted portion of the central conductor extends from the one end side of the central conductor to the other end side of the central conductor and is twisted in a counterclockwise direction. The peripheral conductor has a shape in which a right-twisted portion of the peripheral conductor and a left-twisted portion of the peripheral conductor are arranged alternately at predetermined intervals. The right-twisted portion of the peripheral conductor extends from one end side of the peripheral conductor to the other end side of the peripheral conductor and is twisted in the clockwise direction, and the left-twisted portion of the peripheral conductor extends from the one end side of the peripheral conductor to the other end side of the peripheral conductor and is twisted in the counterclockwise direction. The peripheral conductor is arranged around the central conductor so that a twist direction of the peripheral conductor arranged around the central conductor is an opposite direction of a twist direction of the central conductor.

According to this structure, since the twist direction of the peripheral conductor and the twist direction of the central conductor are opposite to each other, twist deformation that occurs in the central conductor and twist deformation that occurs in the peripheral conductor cancel each other. As a result, twist deformation that occurs in the assembled conductor is suppressed.

The right-twisted portion of the peripheral conductor arranged around the central conductor may be arranged around the left-twisted portion of the central conductor, and the left-twisted portion of the peripheral conductor arranged around the central conductor may be arranged around the right-twisted portion of the central conductor. Further, a boundary between the right-twisted portion of the peripheral conductor and the left-twisted portion of the peripheral conductor may be arranged around a boundary between the left-twisted portion of the central conductor and the right-twisted portion of the central conductor. Furthermore, a twist pitch of the peripheral conductor may be larger than a twist pitch of the central conductor. The twist pitch is a distance between a reference point and a measuring point, in which a twist angle becomes 360 degree, in an axis direction of the central conductor or an axis direction of the peripheral conductor. The twist angle is an intersection angle, which is made by twisting, between a side of the reference point and a side of the measuring point.

According to this structure, it is ensured even more that twist distortion that occurs in the assembled conductor is suppressed.

Meanwhile, a manufacturing method for an assembled conductor, which is formed by rolling a conductor bundle, according to an aspect of the invention includes forming a central conductor having a shape in which a right-twisted portion of the central conductor and a left-twisted portion of the central conductor are arranged alternately in predetermined intervals. The right-twisted portion of the central conductor extends from one end side of the central conductor to the other end side of the central conductor and is twisted in a clockwise direction, and the left-twisted portion of the central conductor extends from the one end side of the central conductor to the other end side of the central conductor and is twisted in a counterclockwise direction. The manufacturing method also includes forming the conductor bundle by arranging a peripheral conductor around the central conductor, and twisting the peripheral conductor in an opposite direction of a twist direction of the central conductor while gripping the conductor bundle.

According to this structure, since the twist direction of the peripheral conductor and the twist direction of the central conductor are opposite to each other, twist deformation that occurs in the central conductor and twist deformation that occurs in the peripheral conductor cancel each other. As a result, twist deformation that occurs in the assembled conductor is suppressed.

Gripping force (for example, chucking force) for gripping the conductor bundle when twisting the peripheral conductor may be strong enough to twist the peripheral conductor while maintaining a state where the peripheral conductor is separated from the central conductor when the conductor bundle is gripped.

According to this structure, it is possible to twist the peripheral conductor while suppressing torsion.

According to the invention, it is possible to provide an assembled conductor that suppresses twist deformation, and a manufacturing method for the assembled conductor.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view of an assembled conductor according to a first embodiment;

FIG. 2 is a sectional view of the assembled conductor according to the first embodiment;

FIG. 3 is a side view of a central conductor according to the first embodiment;

FIG. 4 is a sectional view of the central conductor according to the first embodiment;

FIG. 5 is a flowchart of a manufacturing method according to the first embodiment;

FIG. 6 is a schematic view of the manufacturing method according to the first embodiment;

FIG. 7 is a graph showing twisting torque and an inner diameter after chucking with respect to chucking force;

FIG. 8 is a sectional view of a twisted assembled conductor according to the first embodiment;

FIG. 9 is a sectional view of a twisted assembled conductor according to a reference example 1;

FIG. 10 is a graph showing a twist angle with respect to a twist pitch;

FIG. 11 is a perspective view showing an assembled conductor according to a related art;

FIG. 12 is a schematic view showing a related manufacturing method;

FIG. 13 is a schematic view showing twist deformation of an assembled conductor according to the related art;

FIG. 14 is a graph showing a twist angle with respect to measuring points according to the related art; and

FIG. 15 is a sectional view of a coated assembled conductor with twist deformation according to the related art.

### DETAILED DESCRIPTION OF EMBODIMENTS

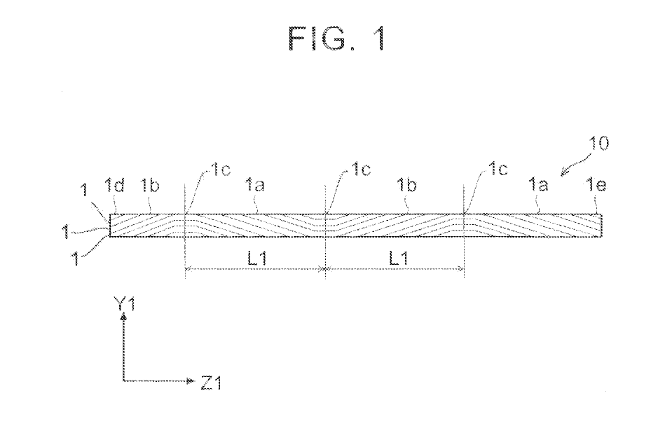

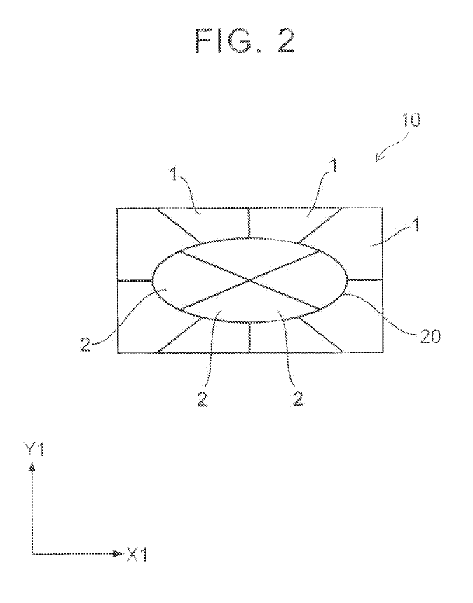

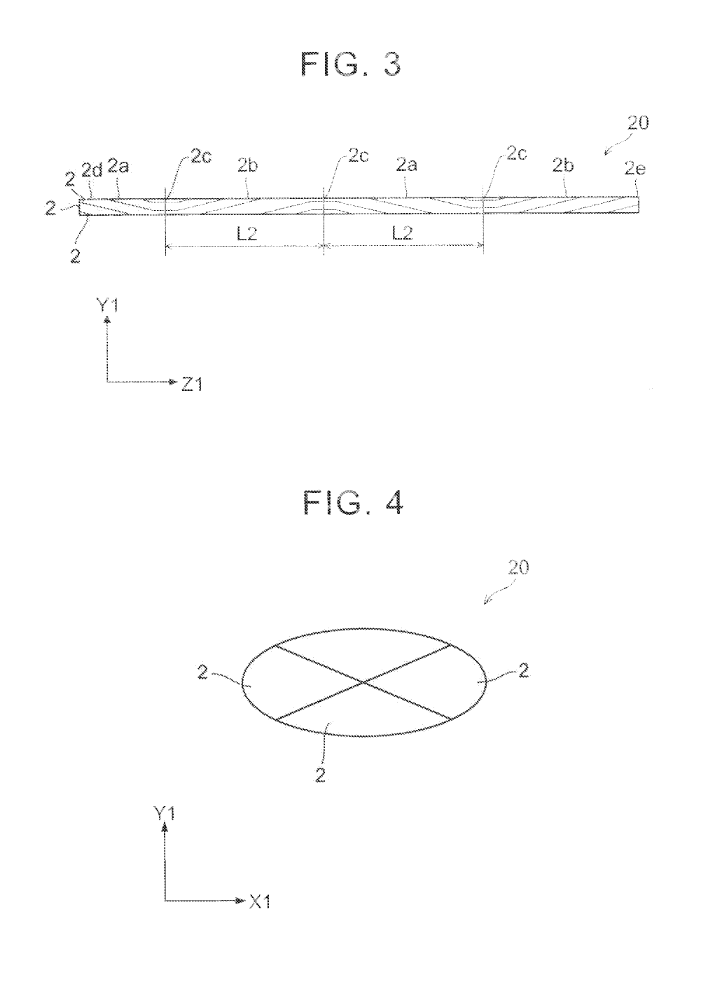

First Embodiment: (Assembled conductor) Referring to FIG. 1 to FIG. 4, an assembled conductor according to the first embodiment is explained. FIG. 1 is a side view of an assembled conductor according to the first embodiment. FIG. 2 is a sectional view of the assembled conductor according to the first embodiment. FIG. 3 is a side view of a central conductor according to the first embodiment. FIG. 4 is a sectional view of the central conductor according to the first embodiment. In FIG. 2 and FIG. 4, hatching is omitted as appropriate for simplicity.

As shown in FIG. 1 and FIG. 2, an assembled conductor 10 includes a central conductor bundle 20, and peripheral conductors 1 arranged around the central conductor bundle 20. The assembled conductor 10 is, for example, a linear body having a given sectional shape such as a rectangular section. The sectional shape of the assembled conductor 10 may be formed by rolling as described later.

As shown in FIG. 3 and FIG. 4, the central conductor bundle 20 is formed by bundling a plurality of central conductors 2. The central conductor bundle 20 has a shape in which a right-twisted portion 2a and a left-twisted portion 2b are arranged alternately in predetermined intervals L2. The right-twisted portion 2a extends from a one end 2d side to the other end 2e side, and is twisted in a clockwise direction. The left-twisted portion 2b extends from the one end 2d side to the other end 2e side, and is twisted in a counterclockwise direction. The central conductor bundle 20 may have a parallel portion 2c between the right-twisted portion 2a and the left-twisted portion 2b. The parallel portion 2c extends from the one end side to the other end side without a twist, in other words, extends substantially in parallel to the axis of the central conductor bundle 20. In the first embodiment, the central conductor bundle 20 is used. However, only one central conductor 2 may be used.

Referring to FIG. 1 and FIG. 2 again, the peripheral conductor 1 has a shape in which a right-twisted portion 1a and a left-twisted portion 1b are arranged alternately at predetermined intervals L1. The right-twisted portion 1a extends from one end 1d side to the other end 1e side and is twisted in the clockwise direction, and the left-twisted portion 1b extends from the one end 1d side to the other end 1e side and is twisted in the counterclockwise direction. Specifically, the peripheral conductors 1 are arranged around the central conductor bundle 20 so that a twist direction of the peripheral conductors 1 is opposite to a twist direction of the central conductor bundle 20. The right-twisted portion 1a of the peripheral conductor 1 is arranged around the left-twisted portion 2b of the central conductor bundle 20, and the left-twisted portion 1b of the peripheral conductor 1 is arranged around the right-twisted portion 2a of the central conductor bundle 20. Further, a boundary between the right-twisted portion 1a of the peripheral conductor 1, and the left-twisted portion 1b of the peripheral conductor 1 is arranged around a boundary between the left-twisted portion 2b of the central conductor bundle 20 and the right-twisted portion 2a of the central conductor bundle 20.

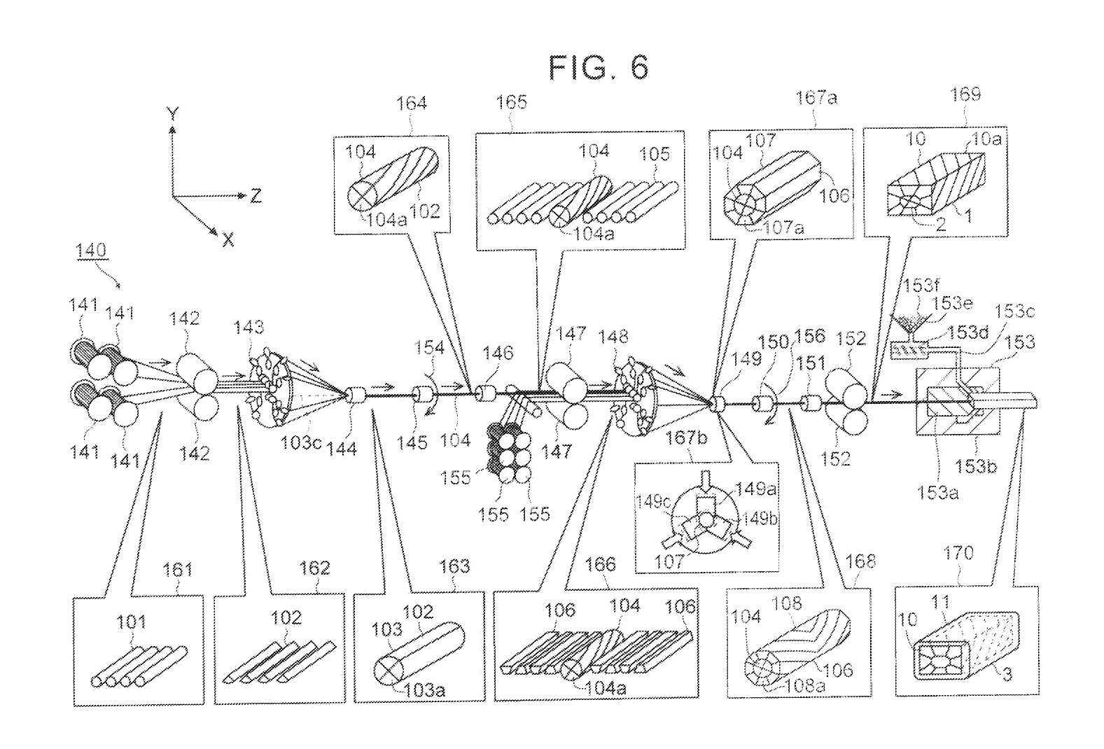

The peripheral conductor 1 may have a parallel portion 1c between the right-twisted portion 1a and the left-twisted portion 1b. The parallel portion 1c extends from the one end 1d side to the other end 1e side without a twist, in other words, to be substantially in parallel to the axis of the central conductor bundle 20. In the axis direction of the central conductor or the axis direction of the peripheral conductor, a distance, in which a twist angle made by twisting reaches 360 degree, is regarded as a twist pitch. In other words, a twist pitch is a distance between a reference point and a measuring point, in which a twist angle becomes 360 degree, and the twist angle is an intersection angle, which is made by twisting, between a side of the reference point and a side of the measuring point. For example, the smaller the twist pitch is, the stronger twisting force is. At this time, it is preferred that the twist pitch of the peripheral conductors is larger than the twist pitch of the central conductors. An insulating film (not shown) is interposed between the central conductors 2, the insulating film (not shown) is interposed between the peripheral conductors 1, and the insulating film (not shown) is interposed between each of the central conductors 2 and each of the peripheral conductors 1, and the conductors are thus insulated from each other. The assembled conductor 10 may further include an insulating film 3 that covers the outer circumference of the assembled conductor 10. As an assembled conductor, which includes the insulating film 3 that covers the outer circumference of the assembled conductor, there is a coated assembled conductor 11 explained later (see schematic view 170 in FIG. 6).

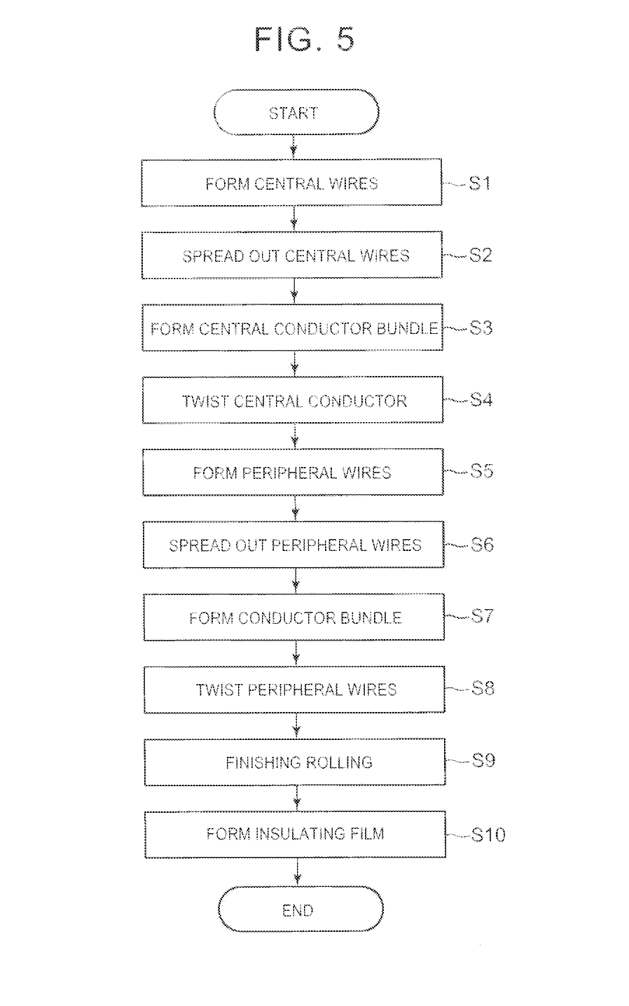

(Manufacturing method) A manufacturing method according to the first embodiment is explained with reference to FIG. 5 and FIG. 6. FIG. 5 is a flowchart of the manufacturing method according to the first embodiment. FIG. 6 is a schematic view of a manufacturing method according to the first embodiment. In FIG. 6, the schematic views 161 to 170 are schematic views showing wires, assembled conductors, or intermediate products of the wires or the assembled conductors in respective steps. Explained here is a manufacturing method for manufacturing the coated assembled conductor 11 from a plurality of wires 101 and so on by using a manufacturing apparatus 140.

As shown in FIG. 6, wire feeders 141 feed the plurality of wires 101 to first rolling mill rolls 142. As shown in schematic view 161, the wires 101 are made of a conductive material and are linear bodies having a generally circular sectional shape.

The first rolling mill rolls 142 receive the plurality of wires 101 from the wire feeders 141 and plastically deform the plurality of wires 101 as shown in schematic view 162, thereby forming central wires 102 (central wire forming step S1). A sectional shape of the central wire 102 is a sector shape. A sectional shape of the central wire 102 may have various shapes other than the sector shape. The central angle of the sector shape in the section of the central wire 102 may be a value obtained by equally dividing 360 degree by the number of central wires 102 so that the section of a central conductor bundle 103 (described later) becomes a circular shape. For example, in a case where there are four central wires 102, the central angle of the central wire 102 is preferably 90 degree. The first rolling mill rolls 142 include a pair of rolls, are rotated by a driving mechanism (not shown), and feed the plurality of central wires 102 to a first conveyer 143. The plurality of central wires 102 are arranged in line in a direction perpendicular to a delivery direction of the central wires 102 (the longitudinal direction of the central wires 102, or a Z-axis direction). To be specific, the central wires 102 are arranged so that arc-shaped circumferences of the central wires 102 face downward.

The first conveyer 143 receives the plurality of central wires 102 from the first rolling mill rolls 142, spreads out the central wires 102, and arranges each of the central wires 102 radially (central wire spreading step S2). Positions and directions of the central wires 102 are adjusted so that the central edge of each of the central wires 102 faces a center axis 103c of the central conductor bundle 103. In short, since the central edges of the central wires 102 are brought closer or in contact with each other by a clamp 144, it is preferred that each of the central wires 102 is arranged so that virtual lines, which extend radially outwardly from the center axis 103c, divide the central wires 102 equally at the central edge of the central wires 102. The first conveyer 143 feeds the plurality of central wires 102 to the clamp 144.

Next, the clamp 144 receives the plurality of central wires 102 from the first conveyer 143. The clamp 144 aligns and bundles the plurality of central wires 102 and forms the central conductor bundle 103 (central conductor bundle forming step S3). The clamp 144 forms the central conductor bundle 103 so that the central edges of the plurality of central wires 102 come into contact with each other. The central conductor bundle 103 has, for example, a circular sectional shape. The clamp 144 applies given pressure to the central conductor bundle 103 towards the center of the central conductor bundle 103. Therefore, in a sectional 103a of the central conductor bundle 103, the central wires 102 are brought closer or come into contact with each other. The central conductor bundle 103 is passed through the clamp 144 and a rotating machine 145, and then fed to a clamp 146.

The clamp 144, the rotating machine 145, and the clamp 146 clamp the central conductor bundle 103 and fix the axis of the central conductor bundle 103. Further, while the clamp 144, the rotating machine 145, and the clamp 146 are clamping the central conductor bundle 103, the rotating machine 145 rotates in a given rotating direction 154 and twists the central conductor bundle 103 (central conductor twisting step S4). Then, a twisted central conductor bundle 104 is formed. The twisted central conductor bundle 104 has, for example, a right-twisted portion and a left-twisted portion, which are bordered by the rotating machine 145. The right-twisted portion extends towards a delivery direction of the central conductor bundle 103 (the longitudinal direction of the central conductor bundle 103, or the Z-axis direction) and is twisted in a clockwise direction. The left-twisted portion extends towards the delivery direction of the central conductor bundle 103 and is twisted in a counterclockwise direction. The central conductor bundle 103 may further include a parallel portion between the right-twisted portion and the left-twisted portion. The parallel portion extends substantially in parallel to the axis of the central conductor bundle 103.

As shown in schematic view 164, the twisted central conductor bundle 104 is an assembled conductor in which the central wires 102 having a given shape are aligned. Therefore, the rotating machine 145 is able to form a section 104a that maintains the substantially circular shape of the section 103a of the central conductor bundle 103.

Second rolling mill rolls 147 not only receive the twisted central conductor bundle 104 from the clamp 146, but also receive a plurality of wires 105 from wire feeders 155. As shown in schematic view 166, the second rolling mill rolls 147 plastically deform the plurality of wires 105 and form peripheral wires 106 (peripheral wire forming step S5). A sectional shape of the peripheral wire 106 only needs to be deformed from an isotropic circular shape that is not changed by rotation the peripheral wire 106, into an anisotropic sectional shape that is changed by rotation the peripheral wire 106. For example, the sectional shape of the peripheral wire 106 is changed into a trapezoid in which an upper base and a lower base have different lengths. The anisotropic sectional shape may be, for example, a trapezoid, a sector shape, an arc shape, and a triangle. Each of the peripheral wires 106 and the twisted central conductor bundle 104 are arranged in parallel. In short, each of the peripheral wires 106 and the twisted central conductor bundle 104 are arranged in line in a direction perpendicular to the delivery direction of the twisted central conductor bundle 104 (the longitudinal direction of the twisted central conductor bundle 104, or the Z-axis direction). The twisted central conductor bundle 104 is arranged near the center of the line of the peripheral wires 106. To be more specific, the peripheral wires 106 are arranged so that a surface corresponding to the upper base of the trapezoidal section and a surface corresponding to the lower base of the trapezoidal section are arranged in line alternately. The second rolling mill rolls 147 include a pair of rolls, are rotated by a driving mechanism (not shown), and feed the twisted central conductor bundle 104 and the plurality of peripheral wires 106 to a second conveyer 148.

The second conveyer 148 receives the twisted central conductor bundle 104 and the plurality of peripheral wires 106 from the second rolling mill rolls 147. The second conveyer 148 spreads out each one of the plurality of peripheral wires 106, and creates a positional relation in which the peripheral wires 106 surround the twisted central conductor bundle 104. To be more specific, the peripheral wires 106 are arranged radially about the twisted central conductor bundle 104 (peripheral wire spreading step S6). At this time, each of the peripheral wires 106 is arranged so that an outer circumference area of the peripheral wire 106 becomes larger than an inner circumference area of the peripheral wire 106. In short, the peripheral wires 106 are arranged so that, out of the upper base and the lower base of the trapezoid in the section of the peripheral wire 106, the longer base is located on an outer side, and the shorter base is located on an inner side.

The second conveyer 148 adjusts positions and directions of the peripheral wires 106 so that the inner circumferences of the peripheral wire 106 face the twisted central conductor bundle 104 side. In short, since the inner circumferences of the peripheral wires 106 need to be located along the outer circumference of the columnar twisted central conductor bundle 104, the peripheral wires 106 are arranged so that a surface including the upper base of the section of the peripheral wire 106 comes to the outer circumference side of the twisted central conductor bundle 104. The second conveyer 148 feeds the plurality of peripheral wires 106 to a clamp 149.

Next, the clamp 149 receives the plurality of peripheral wires 106 from the second conveyer 148. The clamp 149 aligns the plurality of peripheral wires 106, arranges the peripheral wires 106 around the twisted central conductor bundle 104, and forms a bundled conductors or a conductor bundle 107 (conductor bundle forming step S7). Also, the clamp 149 forms the conductor bundle 107 so that the inner circumference of the peripheral wire 106 faces each side of an outer surface of the twisted central conductor bundle 104.

The clamp 149 applies given pressure to the conductor bundle 107 towards the center of the conductor bundle 107. Therefore, as shown in schematic view 167a, the twisted central conductor bundle 104 and the peripheral wires 106 are brought closer to each other, and the peripheral wires 106 are also brought closer to each other in the section of the conductor bundle 107. The conductor bundle 107 is passed through the clamp 149 and a rotating machine 150, and then fed to a clamp 151. As shown in schematic view 167b, the clamp 149 includes a pawl 149a, a pawl 149b, and a pawl 149c. The clamp 149 presses the pawl 149a, the pawl 149b, and the pawl 149c against the conductor bundle 107 by using a fastening part (not shown), and is thus able to clamp the conductor bundle 107 with given chucking force (also referred to as gripping force) Fc. The rotating machine 150 and the clamp 151 have the same structure as that of the clamp 149, and the rotating machine 150 is rotated about the axis of the conductor bundle 107 by a rotation driving part (not shown).

The clamp 149, the rotating machine 150, and the clamp 151 clamp the conductor bundle 107, and fix the axis of the conductor bundle 107. Further, while the clamp 149, the rotating machine 150, and the clamp 151 are clamping the conductor bundle 107, the rotating machine 150 rotates in a given rotating direction 156, and twists the peripheral wires 106 only, without twisting the twisted central conductor bundle 104 (peripheral wire twisting step S8). Then, a twisted conductor bundle 108 is formed. The twisted conductor bundle 108 has a right-twisted portion and a left-twisted portion, which are bordered, for example, by the rotating machine 150. The right-twisted portion is twisted in the clockwise direction, and the left-twisted portion is twisted in the counterclockwise direction, extending towards a delivery direction of the conductor bundle 107 (the longitudinal direction of the conductor bundle 107, or the Z-axis direction). The twisted conductor bundle 108 may further include a parallel portion between the right-twisted portion and the left-twisted portion. The parallel portion extends substantially in parallel to the axis of the twisted central conductor bundle 104.

As shown in a schematic view 168, the twisted conductor bundle 108 is an assembled conductor in which the twisted central conductor bundle 104, and the peripheral wires 106 having a given shape are aligned. Therefore, the rotating machine 150 is able to form a section 108a that maintains the substantially circular shape of the section 107a.

The clamp 149 applies given pressure to the twisted conductor bundle 108 toward the center of the twisted conductor bundle 108. Therefore, the twisted central conductor bundle 104 and the peripheral wires 106 are come into contact with each other, and the peripheral wires 106 are also come into contact with each other.

Third rolling mill rolls 152 receive the twisted conductor bundle 108 from the clamp 151. The third rolling mill rolls 152 include a pair of rolls, are rotated by a driving mechanism (not shown), and roll the twisted conductor bundle 108 so that the twisted conductor bundle 108 becomes rectangular (finishing rolling step S9). From the above-mentioned steps, the assembled conductor 10 is formed. The central conductors 2 are formed from the twisted central conductor bundle 104, and the peripheral conductors 1 are formed from the peripheral wires 106. As stated earlier, the assembled conductor 10 is formed by rolling the twisted conductor bundle 108 in which the central conductors 2 and the peripheral conductors 1 are twisted in opposite directions to each other. Twist deformation that occurs in the central conductors 2, and twist deformation that occurs in the peripheral conductors 1 cancel each other. As a result, twist deformation that occurs in the assembled conductor is reduced. Thus, it is unlikely that twist deformation occurs in the assembled conductor 10.

In addition, the insulating film 3 is formed on an outer circumference of the assembled conductor 10 if necessary (insulating film forming and depositing step S10). In this case, the third rolling mill rolls 152 feed the assembled conductor 10 to an insulating film deposition machine 153. The insulating film deposition machine 153 receives the assembled conductor 10, and the assembled conductor 10 is lead to a die hole of a drawing die 153a. The insulating film deposition machine 153 also softens a raw material 153f loaded in a hopper 153e by heating. Thereafter, the softened raw material 153f is injected into the die hole of the drawing die 153a by a screw 153d, and pressure is applied further to the raw material 153f. Then, the assembled conductor 10 is drawn out from the die hole of the drawing die 153a on the downstream side. Then, the coated assembled conductor 11 is drawn out from the die hole of the drawing die 153a in a state where the insulating film 3 is formed on the circumference of the assembled conductor 10.

From the forgoing, with the manufacturing method according to the first embodiment, it is possible to manufacture an assembled conductor in which twist deformation is suppressed.

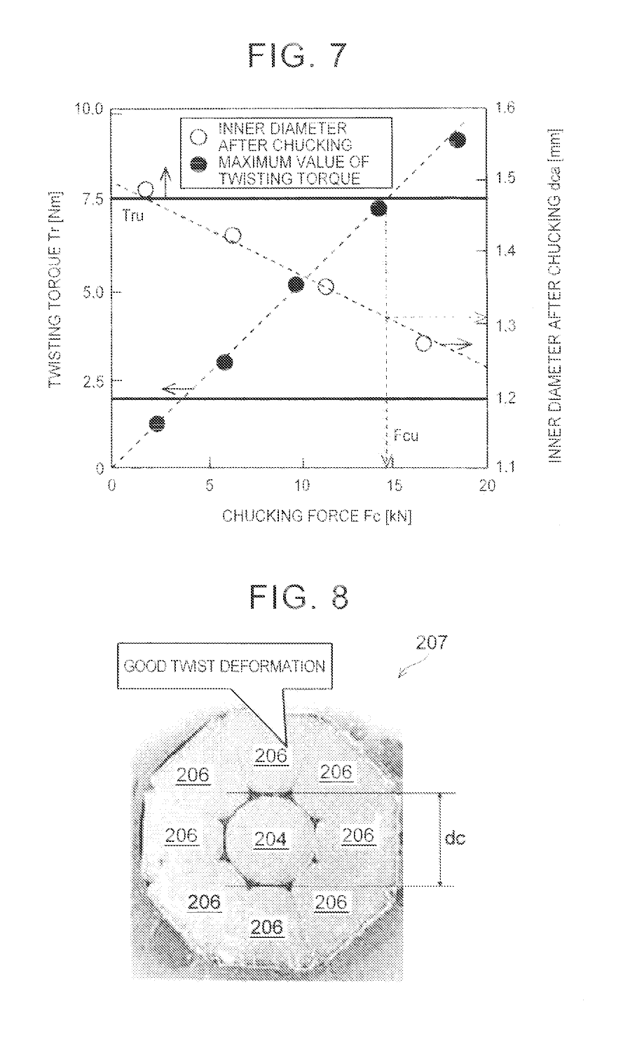

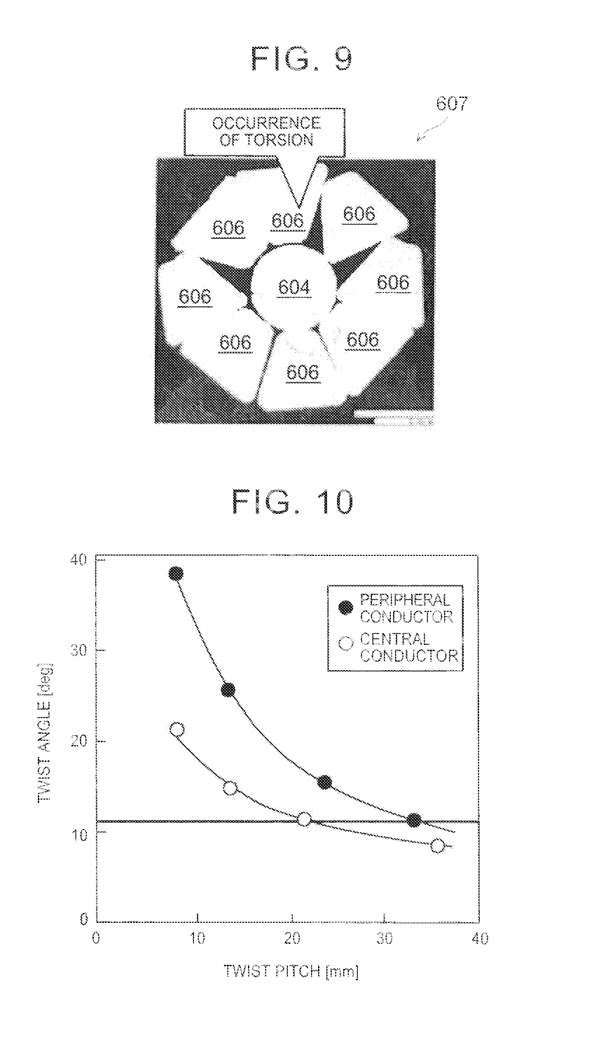

(Diameter of central conductor) Next, a preferred diameter of the central conductor is explained by using FIG. 7 to FIG. 9. FIG. 7 is a graph showing twisting torque and an inner diameter after chucking, with respect to chucking force. FIG. 8 is a sectional view of a twisted conductor bundle according to example 1. FIG. 9 is a sectional view of a twisted conductor bundle according to a reference example 1. Specifically, a preferred diameter of the twisted central conductor bundle 104 in the peripheral wire twisting step S8 in the manufacturing method according to the first embodiment is explained.

Experiment 1 and experiment 2 were carried out by using the manufacturing method according to the first embodiment. One conductor was used as the twisted central conductor bundle 104, and eight conductors having trapezoidal sections were used as the peripheral wires 106. To be specific, experiment 1 was carried out where chucking force at the clamps 149, 151, and the rotating machine 150 in the peripheral wire twisting step S8 was an experimental factor. Further, experiment 2 was carried out where a diameter of the twisted central conductor bundle 104 in the above-mentioned manufacturing method according to the first embodiment was an experimental factor.

(Upper limit value of the preferred diameter of the central conductor) In experiment 1, in a state where the clamps 149, 151 and the rotating machine 150 gripped the conductor bundle 107 with given chucking force Fc, a maximum value Trmax of twisting toque was measured, by which the conductor bundle 107 could be twisted while the conductor bundle 107 are gripped by the clamps 149, 151 and the rotating machine 150 without causing slippage of the conductor bundle 107. FIG. 7 shows measurement results of maximum value Trmax of twisting torque with respect to chucking force Fc.

FIG. 8 shows a sectional view of example 1 carried out in experiment 1. A conductor bundle 207 in example 1 corresponds to the conductor bundle 107 in the manufacturing method according to the first embodiment as shown in schematic view 167a in FIG. 6. Similarly, a central conductor 204 corresponds to the twisted central conductor bundle 104.

As shown in FIG. 8, an inner diameter of a cylindrical body, which is virtually formed by a plurality of peripheral wires 206 is denoted by dc. The inner diameter dc in a state where the conductor bundle 207 is gripped with given chucking force Fc, in other words, an inner diameter after chucking dca, was measured, and the measurement results are shown in FIG. 7.

As shown in FIG. 7, as the chucking force Fc increases, the twisting torque Trmax that can be applied to the peripheral wires 206 tends to increase. On the other hand, the inner diameter after chucking dca is decreased.

Next, a lower limit value Tru of twisting torque required to twist the peripheral wires 206 is obtained. The lower limit value Tru of twisting torque is decided by various conditions such as a size and a material of the peripheral wires 206, and a required twist angle of the peripheral conductors. In this experiment, the lower limit value Tru of twisting torque required to twist the peripheral wires is, for example, 7.5 N·m.

Next, a minimum chucking force Fcu required for applying the lower limit value Tru of twisting torque is obtained. In this experiment, as shown in FIG. 7, the minimum chucking force Fcu required for applying the lower limit value Tru of twisting torque is, for example, about 15 kN.

Next, an inner diameter dc in a state where the peripheral wires 206 are gripped with the minimum chucking force Fcu, in other words, an inner diameter after chucking dca is obtained. In this experiment, as shown in FIG. 7, the inner diameter after chucking dca, in the state where the peripheral wires 206 are gripped with the minimum chucking force Fcu, is about 1.3 mm. When the diameter of the central conductor 204 is smaller than the inner diameter after chucking dca, the peripheral wires 206 are twisted while the peripheral wires 206 are kept separated from the central conductor 204. Therefore, the shape of the central conductor 204 is maintained. It is preferred that the diameter of the central conductor 204 is smaller than the inner diameter after chucking dca. This means that, in this experiment, an upper limit value of the preferred diameter of the central conductor 204 is about 1.3 mm.

(Lower limit value of the preferred diameter of the central conductor) In experiment 2, when the diameter of a central conductor 604 was 1.2 mm or smaller, peripheral wires 606 sometimes became unstable and were turned as shown in FIG. 9. In short, it is considered that, when the diameter of the central conductor 604 was decreased to a given value or smaller, peripheral wires 606 tend to be unstable and torsion of the peripheral wires 606 tends to happen. Thus, it is preferred that the diameter of the central conductor 604 is larger than a given value so that the peripheral wires 606 are twisted stably without torsion. For example, in this experiment, the lower limit value of the preferred diameter of the central conductor is about 1.2 mm.

According to the foregoing, it is preferred that the diameter of the central conductor is a given value or larger so that the peripheral wires are twisted stably. Also, it is preferred that the diameter of the central conductor is a given value or smaller so that the peripheral wires are twisted while being separated from the central conductor. For example, as shown in FIG. 8, in experiment 1 and experiment 2, it is preferred that the diameter of the central conductor 204 is in a range from 1.2 mm or larger to 1.3 mm or smaller, because then the peripheral wires 206 are arranged stably around the central conductor 204 with little torsion of the peripheral wires 206.

(Twist pitch) Next, preferred twist pitches for the central conductor and the peripheral wires are explained by using FIG. 10. FIG. 10 is a graph showing twist angles with respect to twist pitches. Experiment 3 and experiment 4 were carried out in order to obtain preferred twist pitches for the central conductor and the peripheral wires.

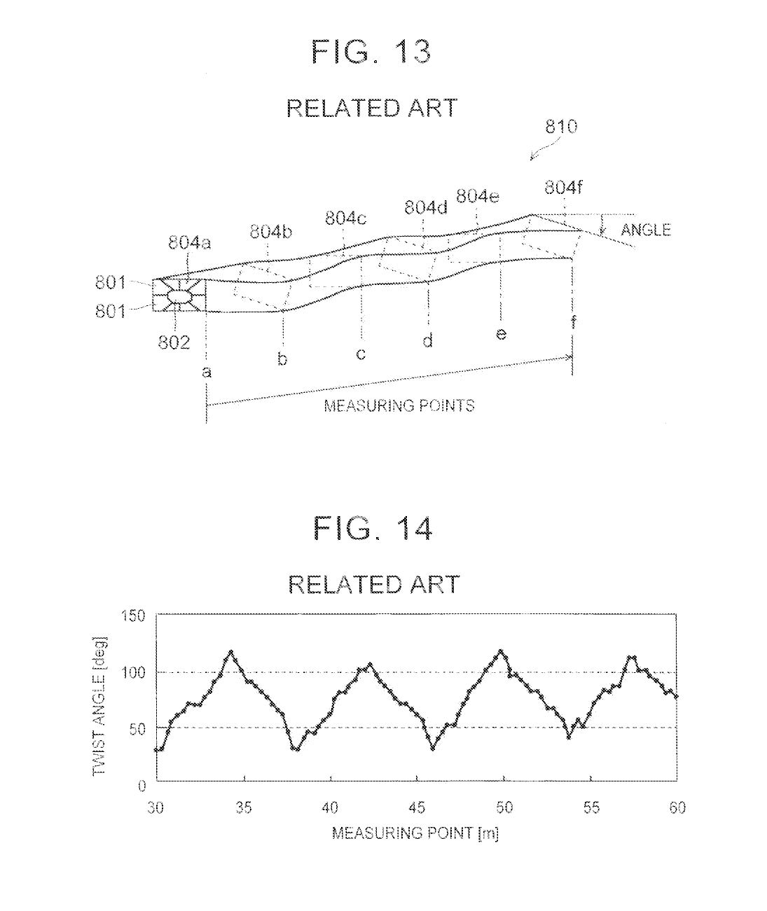

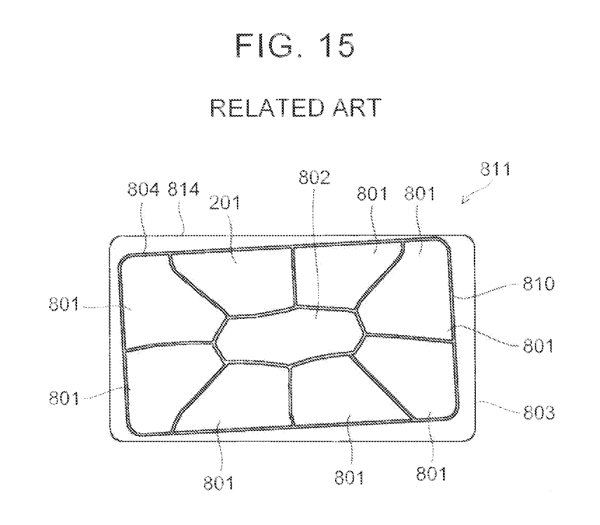

In experiment 3, an assembled conductor, which included eight peripheral conductors and one central conductor, was manufactured by using the manufacturing method according to the first embodiment. Here, the twist pitch in the peripheral wire twisting step S8 was treated as an experimental factor, and a twist angle with respect to each twist pitch was measured. As shown in FIG. 13, the twist angle is an intersection angle between an upper side 804a at a measuring point a serving as a reference, and an upper side 804 (for example, each of an upper side 804b to an upper side 804f, and so on) at each measuring point.

In experiment 4, the foregoing central wire forming step S1 to central conductor twisting step S4, and finishing rolling step S9 were carried out in this order, and an assembled conductor made of four central conductors was made. Here, a twist pitch in central conductor twisting step S4 was treated as an experimental factor, and a twist angle was measured. FIG. 10 shows measurement results of twist angles.

As shown in FIG. 10, as a twist pitch increases, both a twist angle of the peripheral conductor, and a twist angle of the central conductor tend to decrease. With the same or similar twist pitch, the peripheral conductor has a larger twist angle than that of the central conductor. It is presumably because, being located on an outer side of the central conductor, the peripheral conductors substantially affect twist deformation of the assembled conductor.

Therefore, when the twist pitch of the peripheral conductor is larger than the twist pitch of the central conductor, it is not necessary to set a large value for the twist pitch of the central conductor, thereby suppressing twist deformation of the assembled conductor. For example, in this experiment, in the case where a target value of the twist angle is about 10° or smaller, it is preferred that the twist pitch of the peripheral conductor is set to 32 mm, and the twist pitch of the central conductor is set to 21 mm. Thus, the target value of the twist angle is achieved.

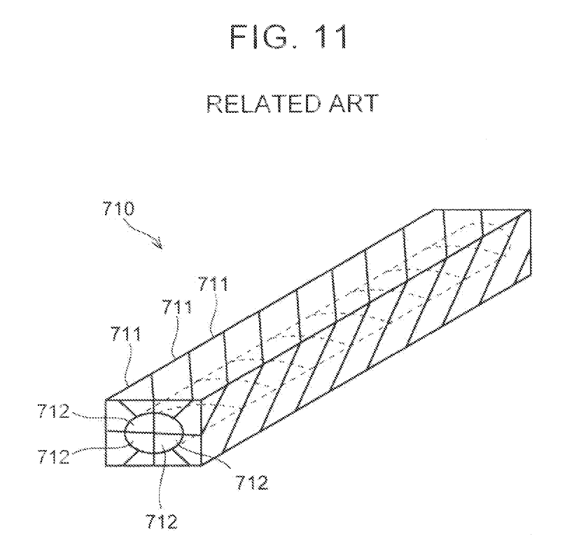

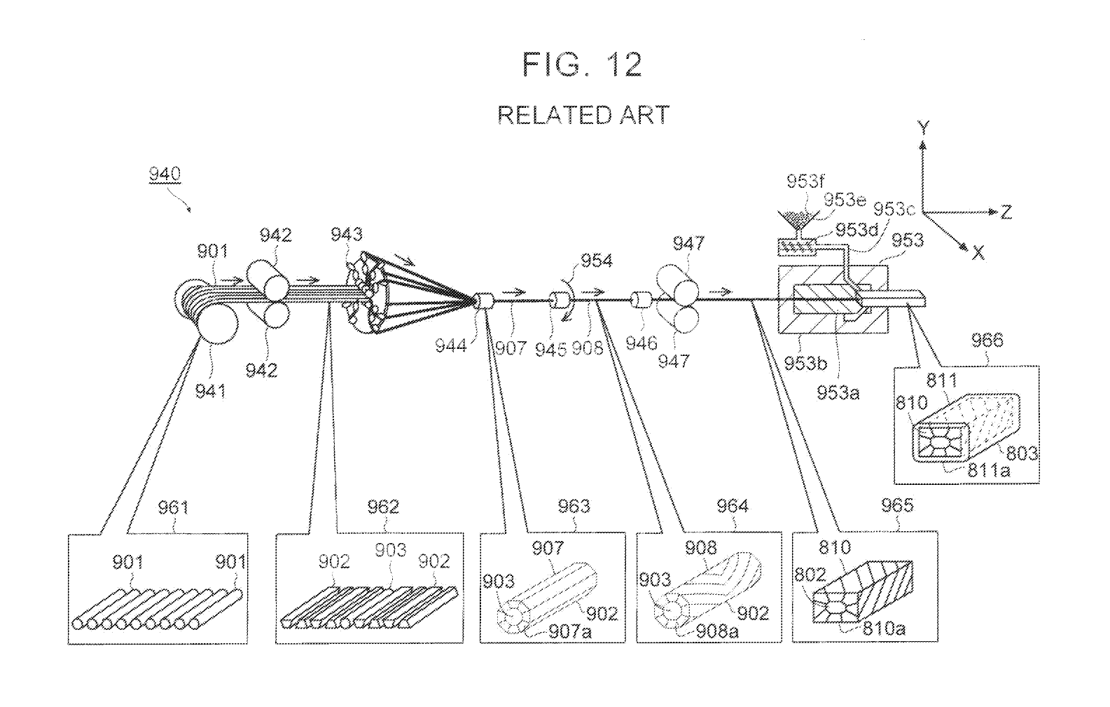

(Comparative example) As a comparative example, a conductor bundle 710 is considered, which includes central conductors and peripheral conductors, which are twisted in opposite directions to each other as shown in FIG. 11. The conductor bundle 710 shown in FIG. 11 includes a plurality of central conductors 712, and a plurality of peripheral conductors 711 arranged around the central conductors 712. As an assembled conductor is manufactured by rolling the conductor bundle 710, twist deformation that occurs in the central conductors 712, and twist deformation that occurs in the peripheral conductors 711 cancel each other. As a result, twist deformation that occurs in the assembled conductor becomes small.

However, in a manufacturing method for such an assembled conductor, it is necessary to continuously rotate the entire central conductors, and the entire peripheral conductors, in one direction, respectively, in order to twist the central conductors and the peripheral conductors, respectively. Thus, a large-sized manufacturing apparatus, such as “continuous twisting equipment” is required.

Meanwhile, in the manufacturing method according to the first embodiment (see FIG. 5), the central conductors and the peripheral conductors are twisted by using the clamps 144 (see FIG. 6), 146, 149, 151, and the rotating machines 145, 150. Therefore, a step for rotating the entire wires such as the wires 101 is not necessary. Thus, the manufacturing apparatus 140 does not need to have a large-sized apparatus, such as continuous twisting equipment, which is able to rotate the entire wires such as the wires 101. The manufacturing apparatus 140 thus tends to be smaller than a large-sized manufacturing apparatus such as the “continuous twisting equipment”.

The invention is not limited to the foregoing embodiment, and may be changed as necessary without departing from the gist of the invention. The assembled conductor obtained by the manufacturing method according to the first embodiment may be used to form a coil, and the coil may be used as a part of a motor.

What is claimed is:

1. An assembled conductor comprising:
a conductor bundle, wherein
the conductor bundle includes a central conductor, and a peripheral conductor arranged around the central conductor,
the assembled conductor is formed by rolling the conductor bundle,
the central conductor has a shape in which a right-twisted portion of the central conductor and a left-twisted portion of the central conductor are arranged alternately at predetermined intervals, the right-twisted portion of the central conductor extending from one end side of the central conductor to the other end side of the central conductor and being twisted in a clockwise direction, and the left-twisted portion extending from the one end side of the central conductor to the other end side of the central conductor and being twisted in a counterclockwise direction,
the peripheral conductor has a shape in which a right-twisted portion of the peripheral conductor and a left-twisted portion of the peripheral conductor are arranged alternately at predetermined intervals, the right-twisted portion of the peripheral conductor extending from one end side of the peripheral conductor to the other end side of the peripheral conductor and being twisted in the clockwise direction, and the left-twisted portion of the peripheral conductor extending from the one end side of the peripheral conductor to the other end side of the peripheral conductor and being twisted in the counterclockwise direction, and
the peripheral conductor is arranged around the central conductor so that a twist direction of the peripheral conductor arranged around the central conductor is an opposite direction of a twist direction of the central conductor.

2. The assembled conductor according to claim 1, wherein
the right-twisted portion of the peripheral conductor arranged around the central conductor is arranged around the left-twisted portion of the central conductor, and
the left-twisted portion of the peripheral conductor arranged around the central conductor is arranged around the right-twisted portion of the central conductor.

3. The assembled conductor according to claim 2, wherein
a boundary between the right-twisted portion of the peripheral conductor and the left-twisted portion of the peripheral conductor is arranged around a boundary between the left-twisted portion of the central conductor and the right-twisted portion of the central conductor.

4. The assembled conductor according to claim 1, wherein
a twist pitch of the peripheral conductor is larger than a twist pitch of the central conductor, the twist pitch being a distance between a reference point and a measuring point, in which a twist angle becomes 360 degree, in an axis direction of the central conductor or an axis direction of the peripheral conductor, and the twist angle being an intersection angle, which is made by twisting, between a side of the reference point and a side of the measuring point.

5. A manufacturing method for an assembled conductor that is formed by rolling a conductor bundle, comprising:
forming a central conductor having a shape in which a right-twisted portion of the central conductor and a left-twisted portion of the central conductor are arranged alternately in predetermined intervals, the right-twisted portion of the central conductor extending from one end side of the central conductor to the other end side of the central conductor and being twisted in a clockwise direction, and the left-twisted portion of the central conductor extending from the one end side of the central conductor to the other end side of the central conductor and being twisted in a counterclockwise direction;
forming the conductor bundle by arranging a peripheral conductor around the central conductor; and
twisting the peripheral conductor in an opposite direction of a twist direction of the central conductor while gripping the conductor bundle.

6. The manufacturing method for the assembled conductor according to claim 5, wherein
gripping force for gripping the conductor bundle when twisting the peripheral conductor is strong enough to twist the peripheral conductor while maintaining a state where the peripheral conductor is separated from the central conductor when the conductor bundle is gripped.
